(19) United States
(12) Patent Application Publication
(10) Pub. No.: US 2005/0221010 A1
(43) Pub. Date: Oct. 6, 2005

(54) Coating material applying method and apparatus with bar

(75) Inventor: Shinsuke Takahashi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/099,443

(22) Filed: Apr. 6, 2005

(30) Foreign Application Priority Data
Apr. 6, 2004 (JP) 2004-111954

(51) Int. Cl. B05C 1/00; B05D 3/12

(52) U.S. Cl. 427/355; 427/359; 118/208; 118/244

(57) ABSTRACT

According to the present invention, the dummy coating layer consisting of the solvent is formed in the end portion in the width direction of the support medium or the location near the end portion, and a coating layer consisting of the coating solution is formed in portions other than the aforementioned portions. Therefore, the coating width can be regulated satisfactorily, and also backward rounding of coating solution to the back surface of support medium can be prevented.

### BACKGROUND OF THE INVENTION

1. Field of the Invention

The present invention relates to a coating material applying method and apparatus with a bar and, more particularly, to a coating material applying method and apparatus with a bar, which are suitable for applying a coating solution to a running band-shaped support medium using a coating bar.

2. Related Art

Photosensitive materials and magnetic recording media are manufactured through a coating process in which a predetermined coating solution such as a magnetic solution is applied onto a continuously running band-shaped support medium (hereinafter referred to as a “web”) to form a coating film. Especially for the magnetic recording medium such as a magnetic recording tape, the capacity and recording density thereof have rapidly increased in recent years for its usage for broadcasting and computers. Therefore, there has been demanded a coating technology capable of obtaining a magnetic layer having a very small film thickness, uniform distribution of film thickness, and a smooth surface.

In addition, such a coating technique has been demanded in manufacturing optical films such as an optical compensation film, a reflection reducing film, and an antiglare film.

As one kind of coating apparatus capable of meeting the above-described demand in the market, a coating material applying apparatus with a bar has conventionally been used. This coating material applying apparatus with a bar is provided with a coating bar consisting of a round rod, and is so configured that a coating solution squeezed out of a slot tip end parallel with the width direction of a running web is transferred and applied to the web via the coating bar. The apparatus of this type has been used widely because it has a simple construction and is capable of forming a thin layer by means of coating.

For the above-described coating material applying apparatus with a bar, a problem has conventionally been pointed out in that if an attempt is made to apply the coating solution over the whole width of web, going around of coating solution to the back surface of web (hereinafter referred to as “backward rounding”) occurs, and hence conveying rollers for conveying the web are contaminated after coating.

To solve this problem, various techniques have conventionally been proposed (for example, Japanese Patent Application Laid-open No. 7-155680). In the technique proposed in this Publication, an injector is provided on the upstream side of the coating material applying apparatus with a bar to apply a solvent of the same kind as the solvent of a coating solution to an uncoated portion of web, and subsequently the coating solution is applied over substantially whole width of web. This Publication has given a description such that in this coating material applying apparatus with a bar, the coating solution will not adhere to the uncoated portion of web, so that an effect of preventing backward rounding can be achieved.

### SUMMARY OF THE INVENTION

However, in the present situation, the technique proposed in Japanese Patent Application Laid-open No. 7-155680 does not meet the recent demand sufficiently.

In recent years, in order to obtain a magnetic layer having a very small film thickness, uniform distribution of film thickness, and a smooth surface by using a coating material applying apparatus with a bar, there is a tendency for the pressure of coating solution in a tip end portion of coating bar to increase. In this case, it is difficult to regulate the coating width. Specifically, in the state in which the pressure of coating solution is high, when a solvent of the same kind as the solvent of coating solution is merely applied to the uncoated portion of web, this solvent is pushed away by the high-pressure coating solution, so that the coating width cannot be regulated.

The present invention has been made in view of the above circumstances, and accordingly an object thereof is to provide a coating material applying method and apparatus with a bar, in which the coating width can be regulated and thereby backward rounding of a coating solution to the back surface of a support medium can be prevented.

To achieve the above object, the present invention provides a coating material applying method with a bar, for transferring and applying a coating solution squeezed out of a slot tip end parallel with the width direction of a support medium to the running band-shape support medium via a coating bar, wherein the coating solution is a liquid consisting of a solvent and a solute; forming a dummy coating layer by applying a liquid with the same composition as the solvent to an end portion in the width direction of the support medium or a location near the end portion by a pre-coating apparatus provided on the upstream side in the running direction of the support medium relative to the coating bar; and after forming the dummy coating layer, transferring and applying the coating solution to portions other than the dummy coating layer of the support medium via the coating bar. The present invention also provides a coating material applying apparatus with a bar for carrying out the method.

According to the present invention, the dummy coating layer consisting of the solvent is formed in the end portion in the width direction of the support medium or the location near the end portion, and a coating layer consisting of the coating solution is formed in portions other than the aforementioned portions. Therefore, the coating width can be regulated satisfactorily, and also backward rounding of coating solution to the back surface of support medium can be prevented.

That is, since the coating solution is not applied onto the dummy coating layer, there does not arise a problem in that the solvent of the dummy coating layer is pushed away by the high-pressure coating solution, and thereby the coating width cannot be regulated.

The pre-coating apparatus is not subject to any special restriction, and as the pre-coating apparatus, a bar coater, a gravure coater (such as a direct gravure coater or a gravure kiss coater), a roll coater (a transfer roll coater or a reverse roll coater), a die coater, an extrusion coater, a fountain coater, an injector, a slide hopper, or the like can be adopted.

In the present invention, the diameter of the coating bar is preferably 6 mm or smaller. In the case where the pressure at the coating point is high, if a coating bar having such a small diameter is used, coating can be performed satisfactorily. In this respect, the diameter of the coating bar is more preferably 4 mm or smaller.

Also, in the present invention, the winding angle of the support medium on the coating bar is preferably set at 10 degrees or larger. In the case where the pressure at the coating point is high, if the winding angle of the support medium on the coating bar is set in such a range, coating can be performed satisfactorily. In this respect, the winding angle is more preferably set at 20 degrees or larger.

Also, in the present invention, the tension of the support medium is preferably set at 98 N/m or higher. In the case where the pressure at the coating point is high, if the tension of the support medium is set in such a range, coating can be performed satisfactorily. In this respect, the tension of the support medium is more preferably set at 196 N/m or higher.

Also, in the present invention, the running speed of the support medium is preferably set at 100 m/min or higher. In the case where the pressure at the coating point is high, if the running speed of the support medium is set in such a range, coating can be performed satisfactorily. In this respect, the running speed of the support medium is more preferably set at 200 m/min or higher.

As described above, according to the present invention, the dummy coating layer consisting of the solvent is formed in the end portion in the width direction of the support medium or the location near the end portion, and the coating layer consisting of the coating solution is formed in portions other than the aforementioned portions. Therefore, the coating width can be regulated satisfactorily, and also backward rounding of coating solution to the back surface of support medium can be prevented.

### BRIEF DESCRIPTION OF THE DRAWINGS

FIG. 1 is a schematic view of a coating line for magnetic recording media to which a method and apparatus for applying coating material with a bar in accordance with the present invention is applied;

FIG. 2 is a sectional view showing a construction of the coating material applying apparatus with a bar shown in FIG. 1;

FIG. 3 is a partially broken perspective view of the coating material applying apparatus with a bar shown in FIG. 1;

FIG. 4 is a schematic view for illustrating thick coating in a coating film end portion in a conventional coating material applying apparatus with a bar;

FIG. 5 is a schematic view of a coating material applying apparatus with a bar in accordance with the present invention for reducing thick coating in a coating film end portion;

FIG. 6 is another schematic view of a coating material applying apparatus with a bar in accordance with the present invention for reducing thick coating in a coating film end portion;

FIG. 7 is a table showing the results of Example 1;

FIG. 8 is a table showing the results of Example 2;

FIG. 9 is a table showing the results of Example 3; and

FIG. 10 is a table showing the results of Example 3.

### DETAILED DESCRIPTION OF THE PREFERRED EMBODIMENTS

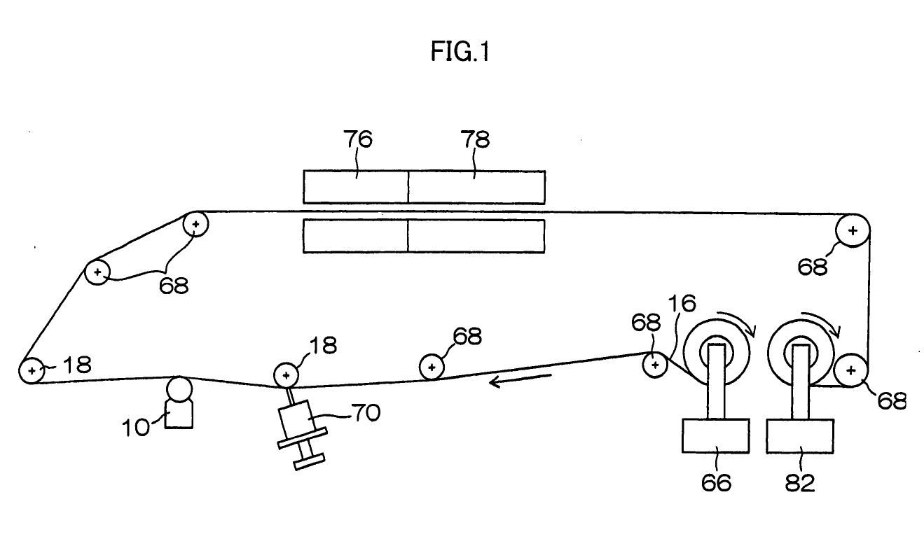

Preferred embodiments of a method and apparatus for applying coating material with a bar in accordance with the present invention will now be described in detail with reference to the accompanying drawings. FIG. 1 is a schematic view of a coating line for magnetic recording media to which the method and apparatus for applying coating material with a bar in accordance with the present invention is applied.

On the coating line for magnetic recording media, as shown in FIG. 1, a web 16, which is a band-shaped flexible support medium, is reeled out of a feeder 66. The web 16 is fed into a pre-coating apparatus 70 by being guided by guide rollers 68. The pre-coating apparatus 70 is provided to apply a solvent to end portions or locations near the end portions in the width direction of the web 16 to form dummy coating layers, and includes two injectors (one injector is shown in the figure).

A coating material applying apparatus 10 with a bar is provided on the downstream side of the pre-coating apparatus 70 so that a coating solution containing a magnetic recording medium can be applied onto the web 16. On the downstream side of the coating material applying apparatus 10 with a bar, a drying zone 76 and a heating zone 78 are provided in consecutive order so that the web is subjected to drying treatment. Finally, the web 16 having been formed with a coating film is wound up by a winder 82 provided on the downstream side.

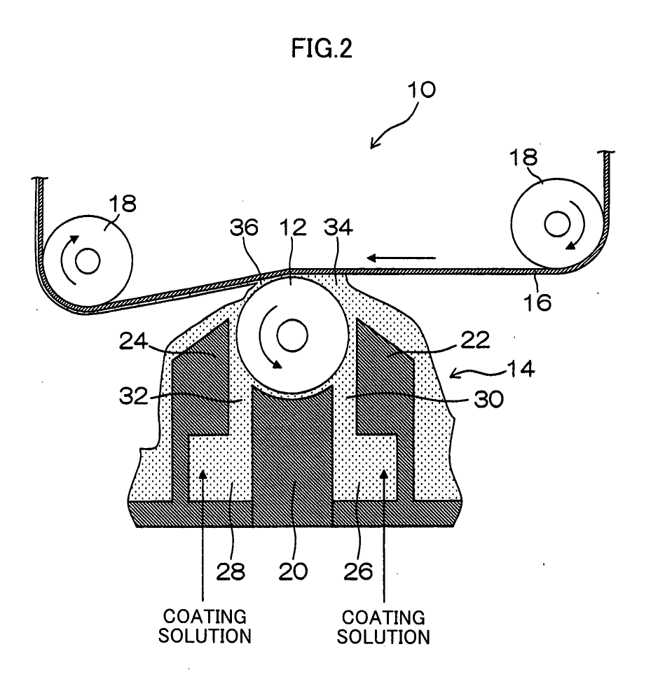

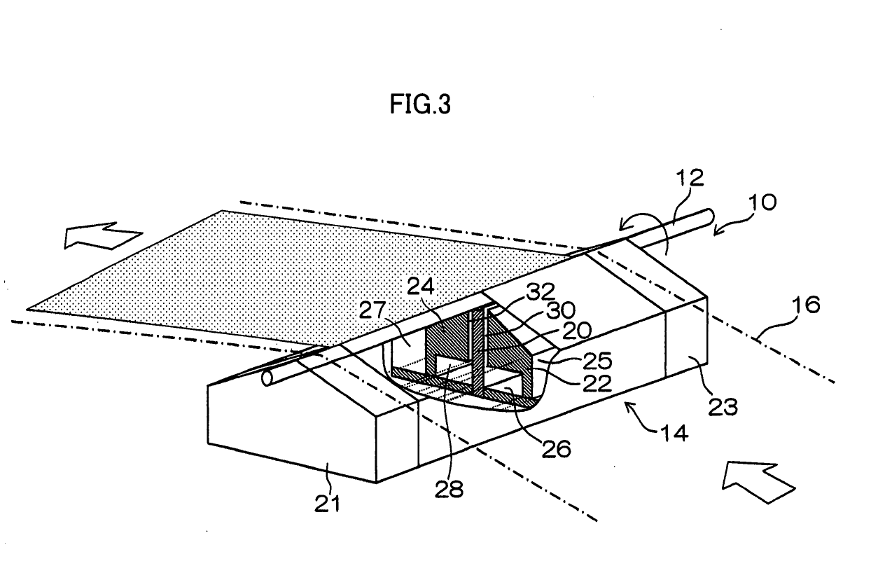

FIG. 2 is a sectional view showing one example of the coating material applying apparatus 10 with a bar in accordance with the present invention, and FIG. 3 is a partially broken perspective view of the coating material applying apparatus 10 with a bar. As shown in FIGS. 2 and 3, the coating material applying apparatus 10 with a bar is mainly made up of a coating head 14 and a pair of guide rollers 18 for guiding the web 16 so that the web 16 runs close to a bar 12.

The coating head 14 is mainly made up of the bar 12, a backup member 20 for rotatably supporting the bar 12, coater blocks 22 and 24, and side blocks 21 and 23 (refer to FIG. 3). Between the backup member 20 and the coater blocks 22 and 24, manifolds 26 and 28 and slots 30 and 32 are formed, and a coating solution is supplied to the manifolds 26 and 28.

The coating solution supplied to the manifold 26, 28 is pushed out through the slots 30, 32, narrow in the web running direction and parallel with the web width direction, so as to be uniform in the web width direction. Thereby, on the upstream side in the feed direction of the web 16 with respect to the bar 12 (hereinafter referred to as “primary side”), a primary-side coating bead 34 is formed, and on the downstream side (hereinafter referred to as “secondary side”), a secondary-side coating bead 36 is formed. Therefore, the bar 12 transfers and applies the coating solution to the running web 16 via the coating beads 34 and 36.

The bar 12 may be configured so as to be rotationally driven or may be supported in a state of being scarcely rotated. In the case where the bar 12 is rotationally driven, it may be rotated in the normal direction or in the reverse direction with respect to the feed direction of the web 16.

The coating solution supplied excessively from the manifold 26, 28 overflows from between the coater block 22, 24 and the web 16, and is recovered via a gutter 25, 27 (refer to FIG. 3). The supply of coating solution to the manifold 26, 28 may be accomplished from a central portion or an end portion of the manifold 26, 28.

Also, the coating head 14 is provided with the side blocks 21 and 23 to regulate the supplied solution width of coating solution and to discharge the overflowing coating solution (which is sometimes reused by providing a return system). The slot width of the slot 30, 32 is set by the side blocks 21 and 23, and the target coating width is determined by regulating the supplied solution width. In this case, if the coating solution is applied to the whole width of the web 16, backward rounding of the coating solution to the back surface of the web 16 occurs. Therefore, the target coating width is set so as to be narrower than the width of the web 16, and coating is performed so as to form uncoated portions at both ends of the web 16.

The supplied solution width can also be regulated by a configuration without the side blocks 21 and 23. In this case, width a regulating plate is disposed within the slot 30, 32 to perform the same operation. This configuration can flexibly respond to the production of magnetic recording medium with different coating widths.

However, if the target coating width is set so as to be narrower than the width of the web 16, there arises a problem in that fluctuations in coating width are large, and hence it is difficult to obtain an effective coating width. The fluctuations in coating width are remarkable as the pressure of coating solution increases. If the target coating width is made narrow, the effective coating width becomes narrow, which decreases the productivity (product yield). On the other hand, if the target coating width is brought closer to the width of the web 16, backward rounding of coating solution to the back surface of the web 16 occurs.

Also, if the target coating width is made narrow taking the fluctuations in coating width into account, another problem sometimes arises. That is, due to the spread of wetting of coating solution pushed out from a location near an end portion of the slot 30, 32, the end portion of coating film is liable to be coated thickly. As a result, line trouble occurs, or both ends of the web 16 must be cut to obtain a product, which decreases the product yield.

Next, the problem of thick coating in the end portions of coating film due to the spread of wetting of coating solution and a solution to the problem will be explained.

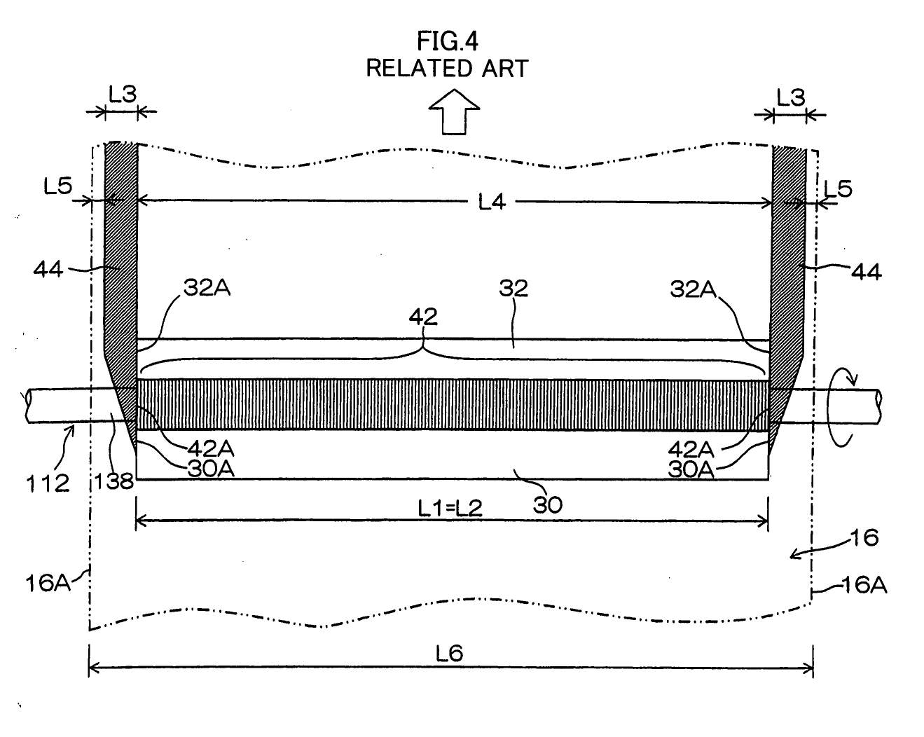

FIGS. 4 to 6 are schematic views schematically showing the relationship between slot end portions 30A and 32A and a web end portion 16A in the case where it is premised that the whole width of the web 16 is not coated. The figures show the coating material applying apparatus 10 with a bar viewed from the upside.

FIG. 4 shows a case of a conventional coating material applying apparatus with a wire bar. The coating solution squeezed out of the slots 30 and 32 is scraped upward by a wire row 42 of a wire bar 112, and is transferred and applied to the web 16. Thereby, a coating film is formed on the surface of the web 16. In FIG. 4, the face length (L2) of the wire row 42 and the slot width (L1) are equal to each other, and the slot end portions 30A and 32A and a wire row end portion 42A are located at the same position in the width direction of the web 16.

However, if the diameters of the wire row 42 and a rod 138 differ from each other as shown in FIG. 4, a thickly coated portion 44 (portion with a width L3) is formed in the coating film end portion. Also, the spread of wetting caused by the surface tension of coating solution squeezed out of a location near the slot end portion 30A, 32A contributes to the formation of the thickly coated portion 44.

In the case of the conventional coating material applying apparatus with a bar, the coating thickness of the thickly coated portion 44 in the coating film end portion is about 4 to 20 times that of the steady coating film (portion with a width L4), and the width (L3) of the thickly coated portion 44 is about 5 to 30 mm. Incidentally, reference character L5 designates the width of an uncoated portion, and L6 designates the width of the web 16.

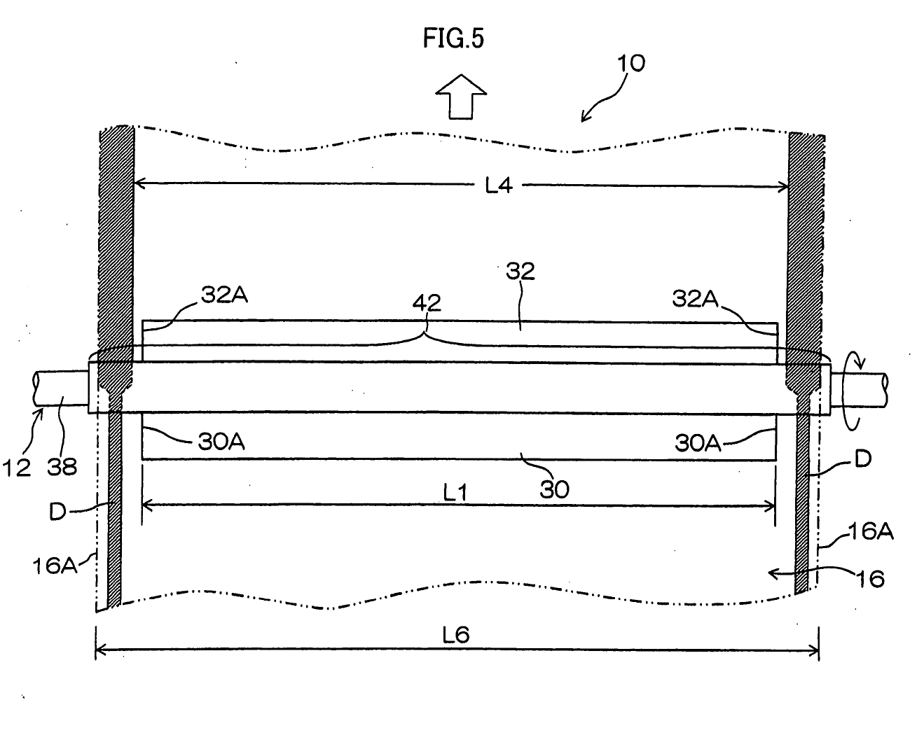

FIG. 5 shows one mode of the coating material applying apparatus 10 with a bar in accordance with the present invention, in which measures are taken to reduce thick coating in the coating film end portion. The apparatus 10 of this mode differs from the conventional coating material applying apparatus with a bar shown in FIG. 4 in that the wire bar 112 is not used, and only the bar 12 (what is called a flat bar or a plane bar) around which a wire is not wound is used.

According to the coating material applying apparatus 10 with a bar shown in FIG. 5, the coating solution squeezed out of the location near the slot end portion 30A, 32A is wetly spread by the surface tension thereof, and the coating width tends to increase as compared with the target coating width. However, a dummy coating layer D consisting of a solvent in the end portion in the width direction of the web 16 or in a location near the end portion is first spread wetly by the bar 12, and the spread of wetting of coating solution is restrained by the wetly spread dummy coating layer D, so that the coating width becomes L4, and the coating solution will not spread wetly.

Also, since the spread of wetting of coating solution is restrained by the dummy coating layer D located on the outside of the slot end portion 30A, 32A, the quantity of coating solution spread wetly is remarkably small as compared with the conventional coating material applying apparatus with a bar shown in FIG. 4. Thereby, the thickly coated portion 44 (portion with the width L3 in FIG. 4) is not formed in a coating film end portion. Therefore, both of the prevention of backward rounding of coating solution to the back surface of the web 16 and the decrease in thick coating in the coating film end portion can be achieved by a simple construction (for example, the injector used as the pre-coating apparatus 70).

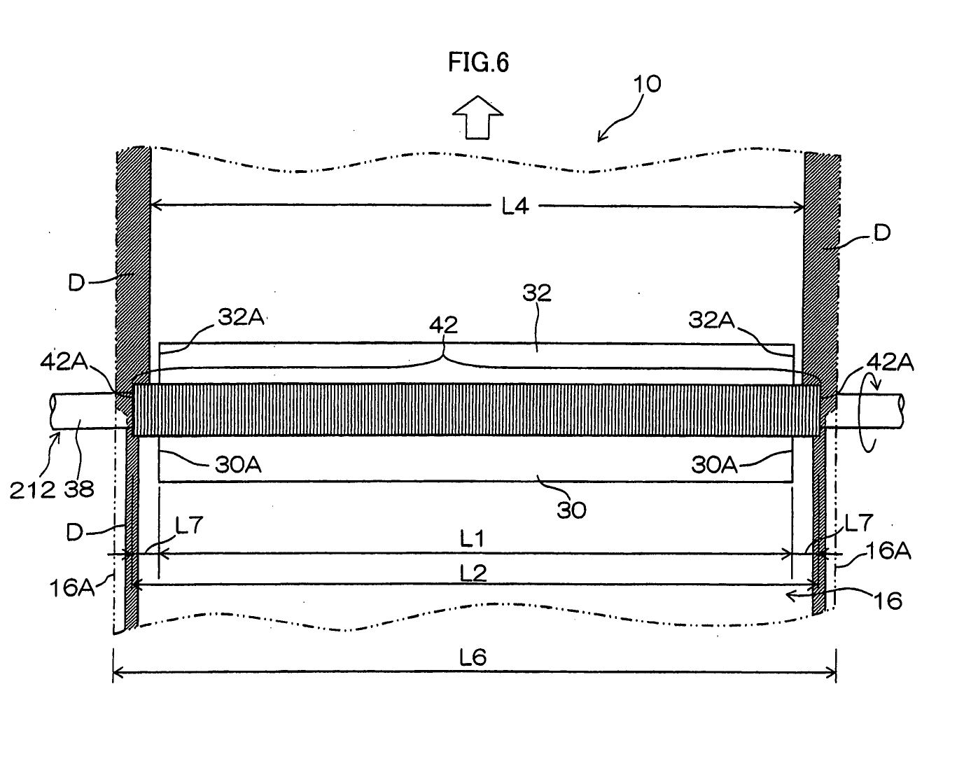

FIG. 6 shows another mode of the coating material applying apparatus 10 with a bar in accordance with the present invention, in which measures are taken to reduce thick coating in the coating film end portion. The coating material applying apparatus 10 of this mode, in which a wire bar 212 is used, is configured so that the face length (L2) of the wire row 42 is longer than the slot width (L1) and shorter than the web width (L6), and thus the wire row end portion 42A is located between the web end portion 16A and the slot end portions 30A and 32A. Also in FIG. 6, as in the configuration shown in FIG. 5, the wire row end portion 42A may be located on the outside of the web end portion 16A.

Specifically, a wire bar 212 having the face length (L2) of the wire row 42 longer than the slot width (L1) is prepared, or the coater blocks 22 and 24 having the slot width (L1) shorter than the face length (L2) of the wire row 42 is prepared.

According to the coating material applying apparatus 10 with a bar shown in FIG. 6, the construction of the coating material applying apparatus 10 with a bar and the presence of the dummy coating layers D concur to achieve a beneficial effect. Specifically, the coating solution squeezed out of the location near the slot end portion 30A, 32A is wetly spread in the direction of the wire row end portion 42A by the surface tension thereof, and the coating width tends to increase as compared with the target coating width. However, the dummy coating layer D located on the outside of the slot end portion 30A, 32A spreads wetly in the portion of the wire row 42, which restrains the spread of wetting of coating solution. Therefore, the coating width becomes L4, and the quantity of coating solution spread wetly is remarkably small as compared with the conventional coating material applying apparatus with a bar shown in FIG. 4.

Thereby, the thickly coated portion 44 (portion with the width L3 in FIG. 4) is not formed in a coating film end portion. Therefore, both of the prevention of backward rounding of coating solution to the back surface of the web 16 and the decrease in thick coating in the coating film end portion can be achieved by a simple construction (for example, the injector used as the pre-coating apparatus 70).

As the web 16 used in the present invention, a plastic film consisting of polyethylene terephthalate, polyethylene-2, 6 naphthalate, cellulose diacetate, cellulose triacetate, cellulose acetate propionate, polyvinyl chloride, polyvinylidene chloride, polycarbonate, polyimide, polyamide, etc., paper, paper produced by applying or laminating α-polyolefins with a carbon number of 2 to 10 such as polyethylene, polypropyrene, and ethylene-butene copolymer to paper, or a film produced by forming a preliminary fabrication layer on the surface of metal foil such as aluminum, copper, and tin foil or a band-shaped substrate, generally having a width of 0.3 to 5 m, a length of 45 to 10,000 m, and a thickness of 5 to 200 μm, is used.

The way of wet spreading of coating solution slightly differs depending on coating conditions such as the physical properties (mainly, viscosity and surface tension) of coating solution, the conveying speed of the web 16, the outside diameter of the bar 12, and the wire diameter of the wire bar 212. In the present invention, any publicly known coating solution may be used if it is for forming a coating film on the web 16.

For example, a coating solution containing liquid crystals or a solution containing a reflection reducing component can be used as the coating solution. Regarding the physical properties of coating solution, in the case of organic solvent series, the coating solution has a low viscosity (usually, about 0.5 to 20 mPa·s). However, the present invention is applicable to a coating solution with high viscosity up to about 100 mPa·s. Also, the range of surface tension of coating solution is not subject to any special restriction, but the preferable range is about 180 to 350 μN/cm.

The above is a description of one embodiment of the coating material applying method and applying apparatus in accordance with the present invention. The present invention is not limited to the above-described embodiment, and various modes can be adopted.

For example, although the injector is used as a pre-coating apparatus in this embodiment, various types of publicly known coating devices other than the injector, such as a bar coater, a gravure coater, a roll coater, a die coater, an extrusion coater, a fountain coater, and a slide hopper can be adopted. In sum, dummy coating layers have only to be formed by applying a solvent in the end portions in the width direction of the web 16 or in locations near the end portions.

### EXAMPLES

Next, examples of the present invention will be explained. As examples of the present invention, coating was performed by using a coating line for magnetic recording media shown in FIG. 1. As the coating material applying apparatus 10 with a bar, the apparatus having a construction shown in FIGS. 2, 3 and 5 was used.

As the web 16, a PET film with a width of 520 mm and a thickness of 9 μm was used.

As a first coating solution supplied from the injector used as the pre-coating apparatus 70, a mixed solvent of 400 parts by weight of cyclohexanone and 100 parts by weight of methyl ethyl ketone was used. The quantity of the first coating solution supplied from the injector was set at 5 to 25 mL/min per one injector, and the coating width of the dummy coating layer D was set at 2 mm.

As a second coating solution supplied from the coating material applying apparatus 10 with a bar, a solution in which 5 parts by weight of polyester-urethane resin was dissolved in the mixed solvent of 400 parts by weight of cyclohexanone and 100 parts by weight of methyl ethyl ketone was used. A colorant was added to the second coating solution to facilitate discrimination of uncoated portion.

The slot width (L1 in FIG. 5) of the coating material applying apparatus 10 with a bar was 600 mm, and the discharge width was regulated by disposing a plate within the slots 30 and 32. As the bar 12, a total of four kinds of bars each having a diameter of 3, 4, 6 and 12 mm were prepared. The quantity of the second coating solution supplied from the coating material applying apparatus 10 with a bar was set at 2.0 L/min.

The winding angle (lap angle) of the web 16 on the bar 12 in the coating material applying apparatus 10 with a bar, the diameter of the bar 12, the running speed of the web 16, and the tension of the web 16 were unified for each of examples (Examples 1 to 4).

Four kinds of experiments of Example 1 through Example 4 were conducted by changing various conditions. Examples 1 to 4 will be explained in order.

### Example 1

The bar 12 with a diameter of 4 mm was used, and the winding angle (lap angle) of the web 16 on the bar 12 was 15 degrees. The tension of the web 16 was set at 147 N/m (15 kg/m).

While the web 16 was run at a speed of 200 m/min, the bar 12 was rotated in the normal direction at the same speed as that of the web 16, and the second coating solution prepared as described above was applied onto the web 16 from the coating head 14.

In this example, Cases 11 to 13 were cases where the pre-coating apparatus 70 was not used, and Cases 14 to 17 were cases where the pre-coating apparatus 70 was used.

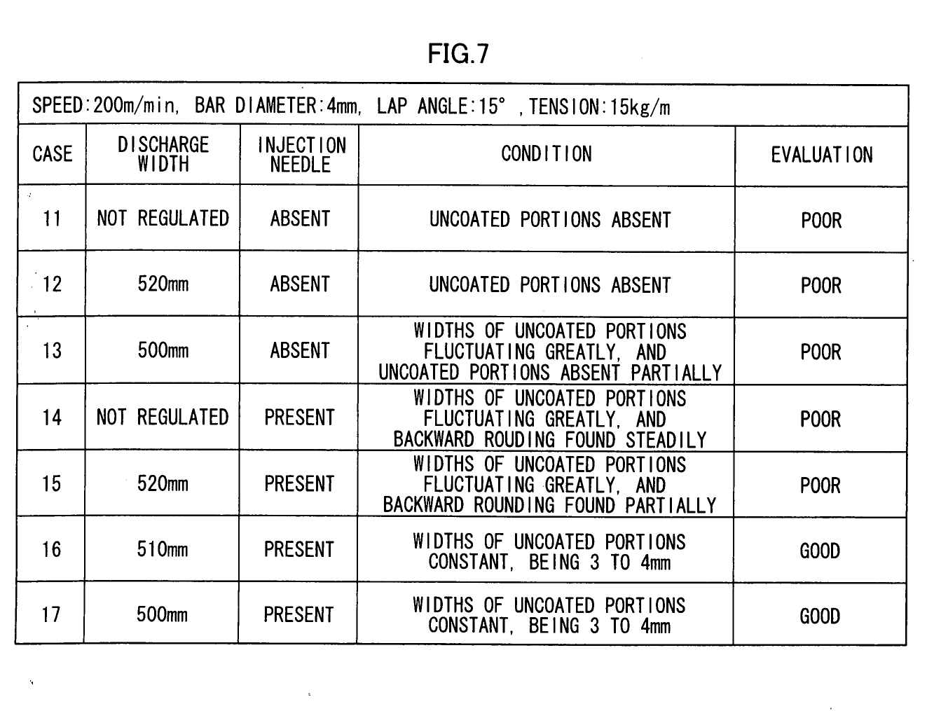

The presence of uncoated portions in the end portions of coating film applied onto the web 16 by the coating material applying apparatus 10 with a bar and the condition of backward rounding were observed, and also comprehensive judgment (three-grade evaluation of Poor, Average, and Good) was made. The results are shown in a table in FIG. 7.

Case 11 in the table in FIG. 7 was a case where the discharge width was not regulated (namely, the discharge width was 600 mm, being the same as the slot width (L1 in FIG. 5)) and the pre-coating apparatus 70 was not used. The observation of coating film proved that the uncoated portions were absent in the coating film end portions, thus the comprehensive judgment result being Poor.

Case 12 was a case where the discharge width was regulated to 520 mm (namely, the same as the width of the web 16) and the pre-coating apparatus 70 was not used. The observation of coating film proved that the uncoated portions were absent in the coating film end portions, thus the comprehensive judgment result being Poor.

Case 13 was a case where the discharge width was regulated to 500 mm and the pre-coating apparatus 70 was not used. The observation of coating film proved that the widths of uncoated portions in the coating film end portions fluctuated greatly and the uncoated portions were absent partially, thus the comprehensive judgment result being Poor.

Case 14 was a case where the discharge width was not regulated (namely, the discharge width was 600 mm, being the same as the slot width (L1 in FIG. 5)) and the pre-coating apparatus 70 was used. The observation of coating film proved that the widths of uncoated portions in the coating film end portions fluctuated greatly, and backward rounding was found steadily, thus the comprehensive judgment result being Poor.

Case 15 was a case where the discharge width was regulated to 520 mm (namely, the same as the width of the web 16) and the pre-coating apparatus 70 was used. The observation of coating film proved that the uncoated portions in the coating film end portions fluctuated greatly, and backward rounding was found partially, thus the comprehensive judgment result being Poor.

Case 16 was a case where the discharge width was regulated to 510 mm and the pre-coating apparatus 70 was used. The observation of coating film proved that the widths of uncoated portions in the coating film end portions were constant, being 3 to 4 mm each, thus the comprehensive judgment result being Good.

Case 17 was a case where the discharge width was regulated to 500 mm and the pre-coating apparatus 70 was used. The observation of coating film proved that the widths of uncoated portions in the coating film end portions were constant, being 3 to 4 mm each, thus the comprehensive judgment result being Good.

The above results revealed that the uncoated portions can be made uniform by using the pre-coating apparatus 70 and by decreasing the discharge width by a predetermined amount or more with respect to the width of the web 16.

### Example 2

As the bar 12 used, three kinds of bars each having a diameter of 4, 6 and 12 mm were used. The winding angle (lap angle) of the web 16 on the bar 12 was 20 degrees. The tension of the web 16 was set at 147 N/m (15 kg/m).

While the web 16 was run at a speed of 200 m/min, the bar 12 was rotated in the normal direction at the same speed as that of the web 16, and the second coating solution prepared as described above was applied onto the web 16 from the coating head 14.

In this example, the pre-coating apparatus 70 was used in all cases (Cases 21 to 26).

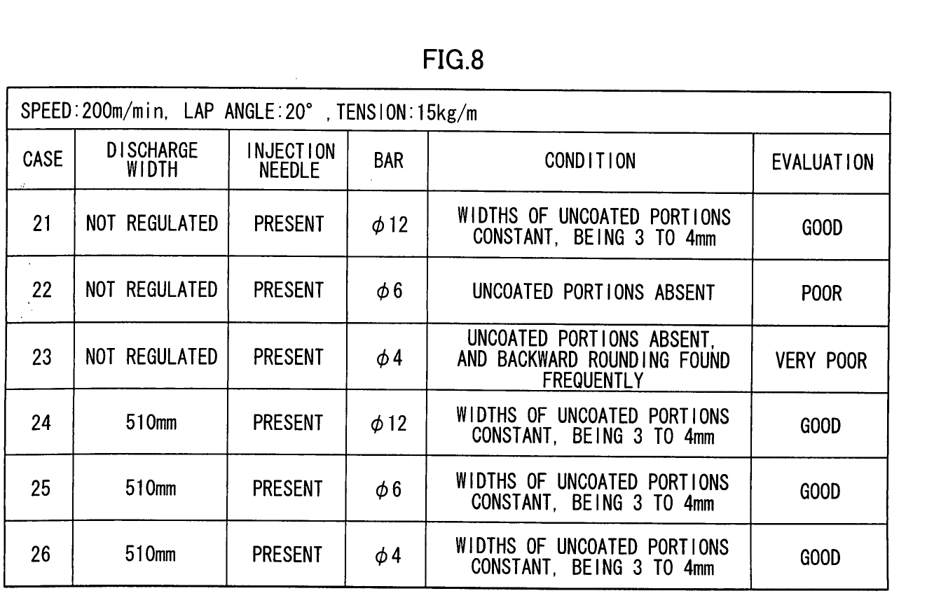

The presence of uncoated portions in the end portions of coating film applied onto the web 16 by the coating material applying apparatus 10 with a bar and the condition of backward rounding were observed, and also comprehensive judgment (three-grade evaluation of Poor, Average, and Good, exceptionally including Very Poor) was made. The results are shown in a table in FIG. 8.

Case 21 in the table in FIG. 8 was a case where the discharge width was not regulated (namely, the discharge width was 600 mm, being the same as the slot width (L1 in FIG. 5)) and the bar 12 with a diameter of 12 mm was used. The observation of coating film proved that the widths of uncoated portions in the coating film end portions were constant, being 3 to 4 mm each, thus the comprehensive judgment result being Good.

Case 22 was a case where the discharge width was not regulated (namely, the discharge width was 600 mm, being the same as the slot width (L1 in FIG. 5)) and the bar 12 with a diameter of 6 mm was used. The observation of coating film proved that the uncoated portions were absent in the coating film end portions, thus the comprehensive judgment result being Poor.

Case 23 was a case where the discharge width was not regulated (namely, the discharge width was 600 mm, being the same as the slot width (L1 in FIG. 5)) and the bar 12 with a diameter of 4 mm was used. The observation of coating film proved that the uncoated portions were absent in the coating film end portions, and backward rounding occurred frequently, thus the comprehensive judgment result being Very Poor.

Case 24 was a case where the discharge width was regulated to 510 mm and the bar 12 with a diameter of 12 mm was used. The observation of coating film proved that the widths of uncoated portions in the coating film end portions were constant, being 3 to 4 mm each, thus the comprehensive judgment result being Good.

Case 25 was a case where the discharge width was regulated to 510 mm and the bar 12 with a diameter of 6 mm was used. The observation of coating film proved that the widths of uncoated portions in the coating film end portions were constant, being 3 to 4 mm each, thus the comprehensive judgment result being Good.

Case 26 was a case where the discharge width was regulated to 510 mm and the bar 12 with a diameter of 4 mm was used. The observation of coating film proved that the widths of uncoated portions in the coating film end portions were constant, being 3 to 4 mm each, thus the comprehensive judgment result being Good.

The above results revealed that even if the diameter of the bar 12 is small (namely, even if the pressure is high), the uncoated portions can be made uniform by using the pre-coating apparatus 70 and by decreasing the discharge width by a predetermined amount or more with respect to the width of the web 16.

### Example 3

The bar 12 with a diameter of 6 mm was used. The tension of the web 16 was set at 98 N/m (10 kg/m). The winding angle (lap angle) of the web 16 on the bar 12 was changed to three stages between 5 and 15 degrees.

While the web 16 was run at a speed of 100 m/min, the bar 12 was rotated in the normal direction at the same speed as that of the web 16, and the second coating solution prepared as described above was applied onto the web 16 from the coating head 14.

In this example, the pre-coating apparatus 70 was used in all cases (Cases 31 to 36).

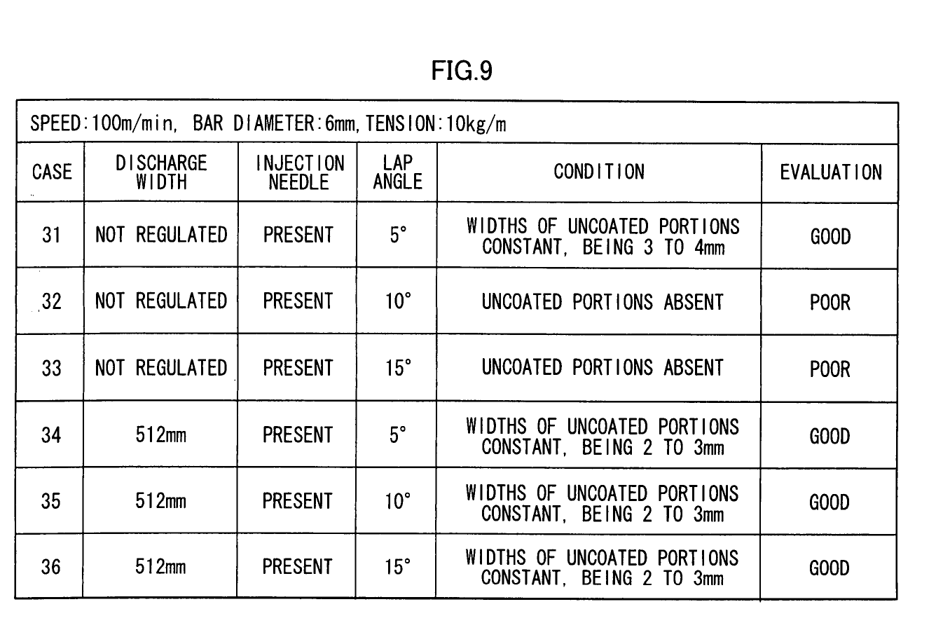

The presence of uncoated portions in the end portions of coating film applied onto the web 16 by the coating material applying apparatus 10 with a bar and the condition of backward rounding were observed, and also comprehensive judgment (three-grade evaluation of Poor, Average, and Good) was made. The results are shown in a table in FIG. 9.

Case 31 in the table in FIG. 9 was a case where the discharge width was not regulated (namely, the discharge width was 600 mm, being the same as the slot width (L1 in FIG. 5)) and the winding angle (lap angle) was 5 degrees. The observation of coating film proved that the widths of uncoated portions in the coating film end portions were constant, being 3 to 4 mm each, thus the comprehensive judgment result being Good.

Case 32 was a case where the discharge width was not regulated (namely, the discharge width was 600 mm, being the same as the slot width (L1 in FIG. 5)) and the winding angle (lap angle) was 10 degrees. The observation of coating film proved that the uncoated portions were absent in the coating film end portions, thus the comprehensive judgment result being Poor.

Case 33 was a case where the discharge width was not regulated (namely, the discharge width was 600 mm, being the same as the slot width (L1 in FIG. 5)) and the winding angle (lap angle) was 15 degrees. The observation of coating film proved that the uncoated portions were absent in the coating film end portions, thus the comprehensive judgment result being Poor.

Case 34 was a case where the discharge width was regulated to 512 mm and the winding angle (lap angle) was 5 degrees. The observation of coating film proved that the widths of uncoated portions in the coating film end portions were constant, being 2 to 3 mm each, thus the comprehensive judgment result being Good.

Case 35 was a case where the discharge width was regulated to 512 mm and the winding angle (lap angle) was 10 degrees. The observation of coating film proved that the widths of uncoated portions in the coating film end portions were constant, being 2 to 3 mm each, thus the comprehensive judgment result being Good.

Case 36 was a case where the discharge width was regulated to 512 mm and the winding angle (lap angle) was 15 degrees. The observation of coating film proved that the widths of uncoated portions in the coating film end portions were constant, being 2 to 3 mm each, thus the comprehensive judgment result being Good.

The above results revealed that even if the winding angle (lap angle) of the web 16 on the bar 12 increases, the uncoated portions can be made uniform by using the pre-coating apparatus 70 and by decreasing the discharge width by a predetermined amount or more with respect to the width of the web 16.

### Example 4

The bar 12 with a diameter of 3 mm was used, and the winding angle (lap angle) of the web 16 on the bar 12 was 15 degrees. The tension of the web 16 was set at 196 N/m (20 kg/m).

While the web 16 was run at a speed of 300 m/min, the bar 12 was rotated in the normal direction at the same speed as that of the web 16, and the second coating solution prepared as described above was applied onto the web 16 from the coating head 14.

In this example, a combination of the position of needle of the injector of the pre-coating apparatus 70 and the discharge width was changed in Cases 41 through 44.

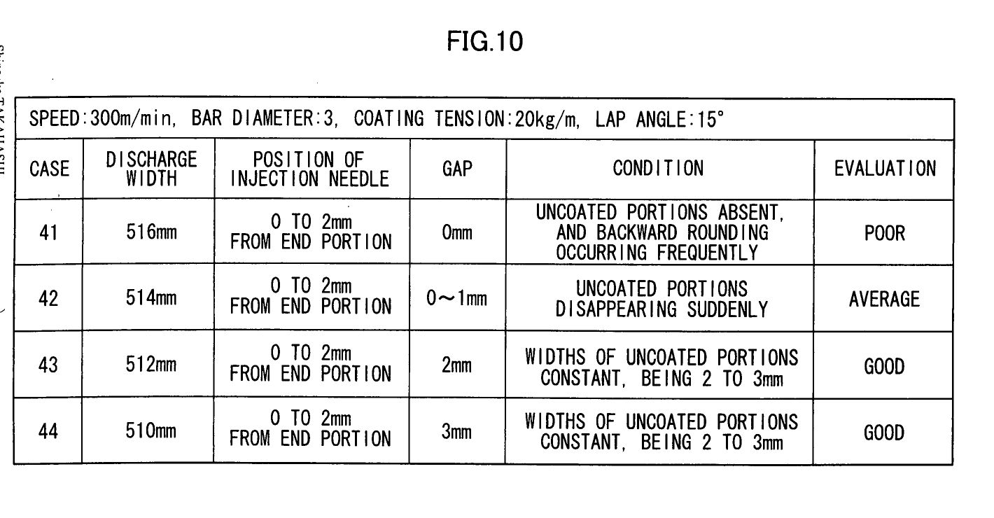

A gap between the first coating solution applied by the injector and the end portion of coating film applied onto the web 16 by the coating material applying apparatus 10 with a bar was actually measured (measured in a portion in which the second coating solution is applied). The presence of uncoated portions in the end portions of coating film applied onto the web 16 by the coating material applying apparatus 10 with a bar and the condition of backward rounding were observed, and also comprehensive judgment (three-grade evaluation of Poor, Average, and Good) was made. The results are shown in a table in FIG. 10.

Case 41 in the table in FIG. 10 was a case where the discharge width was regulated to 516 mm and the needle of injector of the pre-coating apparatus 70 was set at a position 0 to 2 mm distant from the end portion of the web 16. The observation of coating film proved that the gap is 0 mm, the uncoated portions were absent in the coating film end portions, and backward rounding was found sporadically, thus the comprehensive judgment result being Poor.

Case 42 was a case where the discharge width was regulated to 514 mm and the needle of injector of the pre-coating apparatus 70 was set at a position 0 to 2 mm distant from the end portion of the web 16. The observation of coating film proved that the gap is 0 to 1 mm, and the uncoated portions in the coating film end portions disappear suddenly, thus the comprehensive judgment result being Average.

Case 43 was a case where the discharge width was regulated to 512 mm and the needle of injector of the pre-coating apparatus 70 was set at a position 0 to 2 mm distant from the end portion of the web 16. The observation of coating film proved that the gap is 2 mm, and the widths of uncoated portions in the coating film end portions were constant, being 2 to 3 mm each, thus the comprehensive judgment result being Good.

Case 44 was a case where the discharge width was regulated to 510 mm and the needle of injector of the pre-coating apparatus 70 was set at a position 0 to 2 mm distant from the end portion of the web 16. The observation of coating film proved that the gap is 3 mm, and the widths of uncoated portions in the coating film end portions were constant, being 2 to 3 mm each, thus the comprehensive judgment result being Good.

The above results revealed the relationship between the position of needle of the injector of the pre-coating apparatus 70 and the discharge width. Specifically, it was found that the discharge end portion must be located on the inside in the width direction of the layer of solvent (first coating solution) pre-applied by the injector.

1. A coating material applying method with a bar, for transferring and applying a coating solution squeezed out of a slot tip end parallel with the width direction of a support medium to the running band-shape support medium via a coating bar, wherein
the coating solution is a liquid consisting of a solvent and a solute;
forming a dummy coating layer by applying a liquid with the same composition as the solvent to an end portion in the width direction of the support medium or a location near the end portion by a pre-coating apparatus provided on the upstream side in the running direction of the support medium relative to the coating bar; and
after forming the dummy coating layer, transferring and applying the coating solution to portions other than the dummy coating layer of the support medium via the coating bar.

2. The coating material applying method with a bar according to claim 1, wherein the diameter of the coating bar is 6 mm or smaller.

3. The coating material applying method with a bar according to claim 1, wherein the winding angle of the support medium on the coating bar is set at 10 degrees or larger.

4. The coating material applying method with a bar according to claim 2, wherein the winding angle of the support medium on the coating bar is set at 10 degrees or larger.

5. The coating material applying method with a bar according to claim 1, wherein the tension of the support medium is set at 98 N/m or higher.

6. The coating material applying method with a bar according to claim 2, wherein the tension of the support medium is set at 98 N/m or higher.

7. The coating material applying method with a bar according to claim 3, wherein the tension of the support medium is set at 98 N/m or higher.

8. The coating material applying method with a bar according to claim 4, wherein the tension of the support medium is set at 98 N/m or higher.

9. The coating material applying method with a bar according to claim 1, wherein the running speed of the support medium is set at 100 m/min or higher.

10. The coating material applying method with a bar according to claim 2 wherein the running speed of the support medium is set at 100 m/min or higher.

11. The coating material applying method with a bar according to claim 3, wherein the running speed of the support medium is set at 100 m/min or higher.

12. The coating material applying method with a bar according to claim 4, wherein the running speed of the support medium is set at 100 m/min or higher.

13. The coating material applying method with a bar according to claim 5, wherein the running speed of the support medium is set at 100 m/min or higher.

14. The coating material applying method with a bar according to claim 6, wherein the running speed of the support medium is set at 100 m/min or higher.

15. The coating material applying method with a bar according to claim 7, wherein the running speed of the support medium is set at 100 m/min or higher.

16. The coating material applying method with a bar according to claim 8, wherein the running speed of the support medium is set at 100 m/min or higher.

17. A coating material applying apparatus, comprising:
a coating material applying portion with a bar, the coating material applying portion for transferring and applying a coating solution squeezed out of a slot tip end parallel with the width direction of a support medium to the running band-shape support medium via a coating bar; and
a pre-coating portion provided on the upstream side in the running direction of the support medium relative to the coating bar, wherein
a first coating layer is formed by applying a first coating solution to an end portion in the width direction of the support medium or a location near the end portion by the pre-coating portion; and
a second coating layer is formed by transferring and applying a second coating solution to portions other than the first coating layer of the support medium via the coating bar.
